(19) United States
(12) Patent Application Publication
(10) Pub. No.: US 2026/0336343 A1
(43) Pub. Date: Oct. 29, 2026

(54) VEHICLE CONTROL ARM MOUNT

(71) Applicant: COASTAL OFFROAD INCORPORATED, Delta (CA)

(72) Inventor: Brandon Peter FALISZEWSKI, Victoria (CA)

(73) Assignee: COASTAL OFFROAD INCORPORATED, Delta, BC (CA)

(21) Appl. No.: 19/114,525

(22) PCT Filed: Oct. 18, 2022
(86) PCT No.: PCT/IB2022/059987

§ 371 Date: Mar. 24, 2025

(51) Int. Cl. B60G 7/02

(52) U.S. Cl. CPC B60G 7/02; B60G 2200/464; B60G 2204/143; B60G 2204/4302; B60G 2204/4402; B60G 2206/601

(57) ABSTRACT

An apparatus to mount a control arm with a vehicle can include a first flange, a second flange, and a connecting portion that connects the first flange with the second flange. The first flange and the second flange define a gap to receive a mounting plate of a chassis of the vehicle. The apparatus can include a fastener coupled with the first flange and the second flange, the fastener to couple a control arm with the mounting plate.

### BACKGROUND

Vehicles have frames connected to tires for propulsion. The tires are rotatably connected to the frame to provide directional control.

### SUMMARY

An apparatus to mount a control arm with a vehicle. The apparatus can include a first flange, a second flange, and a connecting portion that connects the first flange and the second flange. The first flange, the second flange, and the connecting portion of the apparatus can define a U-shape. The first flange and the second flange define a gap to receive a mounting plate of a chassis of the vehicle. A fastener can couple the first flange to the second flange and the control arm with the mounting plate. The apparatus can connect with both the mounting plate of the chassis and a control arm, such that the control arm is coupled to the vehicle via the apparatus. The apparatus can include a spacer to set a mounting point of the control arm. In this example, the spacer can adjust the mounting point of the control arm between the first flange and the second flange. The apparatus can include with a mounting point such that the control arm is closer to a front of the vehicle, allowing larger tires to be fit to the vehicle without interference from the chassis and increasing the approach angle of the vehicle. The apparatus can include pairs of cam tabs on the first flange and the second flange to engage with cams coupled with the apparatus by the fastener. In this example, the rotational position of the cams when engaged with the cam plates can adjust a camber and caster angle of the vehicle.

At least one aspect is directed to an apparatus to mount a control arm with a vehicle. The apparatus can include a first flange, a second flange, and a connecting portion that connects the first flange with the second flange. The first flange and the second flange define a gap to receive a mounting plate of a chassis of the vehicle. The apparatus can include a fastener coupled with the first flange and the second flange, the fastener to couple a control arm with the mounting plate.

At least one aspect is directed to a system to mount a control arm with a vehicle. The system can include a first flange, a second flange, and a connecting portion that connects the first flange to the second flange. The first flange and the second flange define a gap accessible from a first direction to receive a mounting plate of a chassis of the vehicle. The apparatus can include a fastener coupled with the first flange and the second flange. The gap can be accessible from a second direction to receive a control arm. The fastener can couple the control arm with the mounting plate.

At least one aspect is directed to a method to mount a control arm with a vehicle. The method can include providing an apparatus. The apparatus can include a first flange, a second flange, and a connecting portion that connects the first flange with the second flange. The method can include coupling, with a fastener, the first flange and the second flange. The method can include coupling, with the fastener, the apparatus with a mounting plate of a chassis of the vehicle. The method can include coupling, with the fastener, the apparatus with a control arm.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example control arm mount, in accordance with some aspects.

FIG. 2 depicts an exploded view of an example control arm mount, in accordance with some aspects.

FIG. 3 depicts an example control arm mount, in accordance with some aspects.

FIG. 4 depicts an example control arm mount, in accordance with some aspects.

FIG. 5 depicts an example control arm mount, in accordance with some aspects.

FIG. 6 depicts an example cam set, in accordance with some aspects.

FIG. 7 depicts an example control arm mount installed in a vehicle, in accordance with some aspects.

FIG. 8 depicts an example control arm mount installed in a vehicle, in accordance with some aspects.

FIG. 9 depicts an example control arm mount installed in a vehicle, in accordance with some aspects.

FIG. 10 is a flow chart of an example method to mount a control arm with a vehicle, in accordance with some aspects.

### DETAILED DESCRIPTION

Following below are more detailed descriptions of various concepts related to, and implementations of, methods, apparatuses, and systems related to control arm mounts. The various concepts introduced above and discussed in greater detail below may be implemented in any of numerous ways.

The present disclosure is directed to apparatuses and methods to mount a control arm to a vehicle. The apparatuses and methods can include a control arm mount. The control arm mount can be used to connect a control arm with a chassis of a vehicle. Control arms connect the vehicle chassis with a wheel assembly. The control arm allows the chassis and the wheel assembly to move together, while still allowing for the independent movement of the wheel assembly necessary for propulsion and steering. The mounting point of the control arm to the chassis can affect the size of tires than can be fit to a vehicle and its off-roading characteristics. Smaller tires have improved fuel efficiency but a smaller contact surface leading to reduced grip and traction. Smaller tires also lower the vehicle relative to the road, decreasing the vehicle's ground clearance and approach angle. Larger tires raise a vehicle higher from the road and have an increased contact surface. Generally vehicles are fitted by a manufacturer with smaller tires, and vehicles intended to be used off-road are subsequently modified to increase their off-road capabilities.

The control arm mount can position the mounting point of a control arm further forward than allowed by the manufacturer control arm mount to improve its off-roading capabilities. For example, the control arm mount can include a first flange, a second flange, and a connecting portion that connects the first flange and the second flange to form a U-shaped bracket. The first flange and the second flange can define a gap. The gap can be extended to allow the control arm to be mounted further forward. An original mounting plate of the vehicle can be received in the gap to provide a mounting point and alignment aid to the control arm mount. A fastener couples the first flange and the second flange to the mounting plate, and the control arm mount is welded to the chassis. The first flange and the second flange can include a first aperture and a second aperture, respectively, to receive the fastener. Beneficially, coupling the control arm mount to an original mounting plate of a vehicle reduces the amount of modifications which need to be made to the chassis while also providing a reference point for positioning the control arm mount on the chassis.

The end of the control arm can be pivotally coupled to the control arm mount in the gap between the first flange and the second flange by the fastener. The gap is extended, allowing the mounting point of the end of the control arm relative to the chassis to be moved forward, closer to the front of the vehicle. One or more spacers can be included in the gap defined by the first flange and the second flange to move the mounting point forward. The width or number of spacers can be changed to adjust how far the mounting point is moved. The first flange and the second flange can also include a first pair of cam tabs and a second pair of cam tabs, respectively, to engage with a cams coupled to the control arm mount by the fastener. The rotational position of the cams relative to the cam tabs can adjust a camber angle and additionally a caster angle of the vehicle by moving the mounting point laterally relative to the centerline of the vehicle.

The disclosed solutions have a technical advantage of providing a more forward mounting point for the control arms of a vehicle while reducing the amount of modifications needed to move the mounting point forward. The more forward mounting point allows larger tires to be fitted to the vehicle without interference from the vehicle cab, while also increasing the approach angle of the vehicle. The reduced amount of modifications maintains a larger portion of the chassis' original integrity, and the use of an original mounting plate also provides a reference point for positioning the control arm mount. The disclosed control arm mount also provides a strengthened mounting point and alignment cam system for setting a camber and caster angle of the wheel assembly.

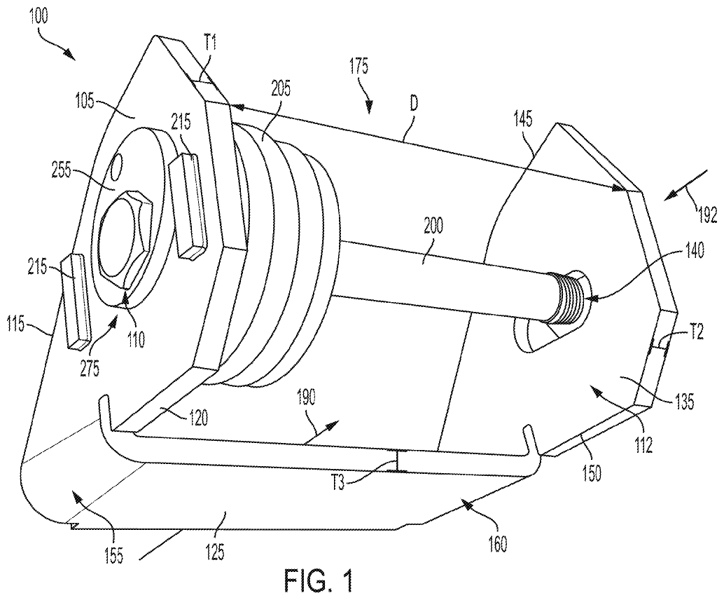

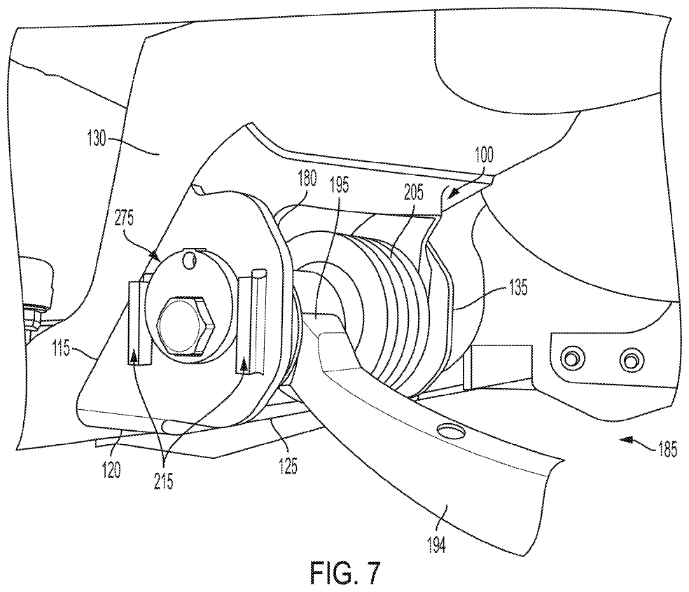

FIGS. 1-5, among others, depict an apparatus 100. The apparatus 100 can be a bracket 100. The bracket 100 can be a control arm mount. For example, the bracket 100 can be a control arm mount that is used to couple a control arm 195 to a chassis 130 of a vehicle 185 (e.g., bracket 100 as depicted in FIG. 7). The bracket 100 can be a control arm mount used to reposition the mounting point 197 of the control arm 195 forward, towards the front of the vehicle 185. The bracket 100 can couple to a mounting plate 180 on the chassis. For example, the bracket 100 can include a first flange 105, a second flange 135, and a connecting portion 125 that connects the first flange 105 with the second flange 135, where the first flange 105 and the second flange 135 define a gap 175 to receive a mounting plate 180 of a chassis 130 of a vehicle 185.

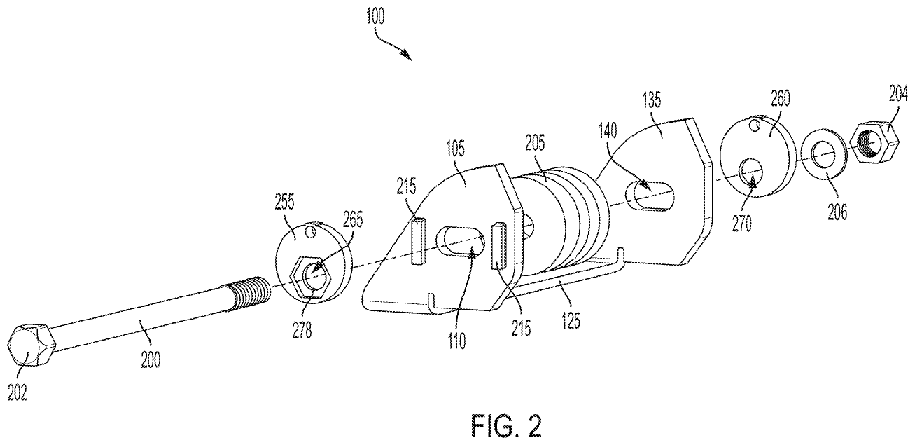

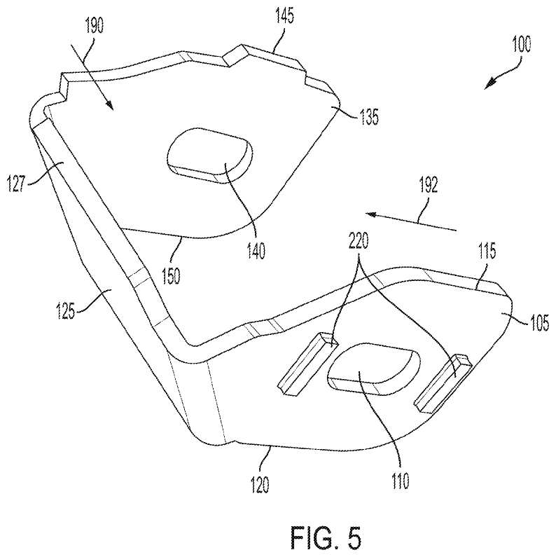

The bracket 100 can include at least one first flange 105. The first flange 105 can be a plate, an extension, a web, or a member. For example, the first flange 105 can be a plate having a thickness T1. As depicted in FIGS. 2-5, among others, the first flange 105 can include at least one first aperture 110. The first aperture 110 can be a polygon or circular (e.g., a circular, rectangular, pentagonal, hexagonal, or another shape.). For example, the first aperture 110 can be an oblong. The first flange 105 can include at least one first side 115 and at least one second side 120. For example, the first flange 105 can have a first side 115 (e.g., a curved side) that is at an angle to a second side 120 (e.g., a bottom side). The angle between the first side 115 and the second side 120 can be greater than, equal to, or less than 90 degrees. For example, the angle can be an acute angle as depicted in FIGS. 1-5. The first side 115 can be positioned directly adjacent to the second side 120 (e.g., the bracket 100 as shown in FIGS. 1-5) or at least one connecting portion 125 can connect the first side 115 to the second side 120 as a third side 127 (e.g., the bracket 100 as shown in FIG. 5). At least a portion of the first side 115 can be shaped to match a profile of a chassis 130 of a vehicle 185. For example, the first side 115 can be shaped such that only a portion of the first side 115 is shaped to match the profile of the chassis 130. The first side 115 can be continuous. For example, the first side 115 can have a surface that substantially (e.g., +/−10%) or entirely is shaped to contact the chassis 130. The first side 115 can include an attachment surface. The attachment surface can be a welding surface, gluing surface, a braising surface, or a surface for another type of connection. For example, the attachment surface can be welding surface for welding the first side 115 to the chassis 130. The welding surface can extend the width of thickness T1. For example, the welding surface can extend along the first side 115 and across the thickness T1. The first side 115 can extend away from the second side 120. For example, the first side 115 can begin below the first aperture 110 and extend away to above the first aperture 110. The second side 120 can be below the first aperture 110 (e.g., a bottom side). For example, the second side 120 can be substantially parallel (e.g., +/−10% of parallel) or parallel with a horizontal surface supporting the vehicle 185, with the first side 115 extending away from the horizontal surface. The terms below and above are in reference to the horizontal surface, such that below is closer to the horizontal surface relative to the other element in the comparison and above is further from the horizontal surface relative to the other element in the comparison.

The bracket 100 can include at least one second flange 135. For example, the second flange 135 can be opposite the first flange 105. The second flange 135 can be a plate, an extension, a web, or a member. For example, the second flange 135 can be a plate having a thickness T2. The second flange 135 can include at least one second aperture 140. The second aperture 140 can be a polygon or circular (e.g., a circular, rectangular, pentagonal, hexagonal, or another shape.). For example, the second aperture 140 can be an oblong as depicted in FIG. 4. The second aperture 140 can be axially aligned with the first aperture 110. For example, a straight line can pass through the first aperture 110 and the second aperture 140. The second flange 135 can include at least one first side 145 and at least one second side 150. For example, the second flange 135 can have a first side 145 (e.g., a curved side) that is at an angle to a second side 150 (e.g., a bottom side). The angle between the first side 145 and the second side 150 can be greater than, equal to, or less than 90 degrees. For example, the angle can be an acute angle as depicted in FIGS. 1-5. The first side 145 can be positioned directly adjacent to the second side 150 (e.g., the bracket 100 as shown in FIGS. 1-5) or a connecting portion 125 can connect the first side 145 to the second side 150 as a third side 127 (e.g., the bracket 100 as shown in FIG. 5). At least a portion of the first side 145 can be shaped to match a profile of a chassis 130 of a vehicle 185. For example, the first side 145 can be shaped such that only a portion of the first side 145 is shaped to match the profile of the chassis 130. The first side 145 can be continuous. For example, the first side 145 can have a surface that substantially (e.g., +/−10%) or entirely is shaped to contact the chassis 130. The first side 145 can include an attachment surface. The attachment surface can be a welding surface, gluing surface, a braising surface, or a surface for another type of connection. The welding surface can extend the width of thickness T2. For example, the welding surface can extend along the first side 115 and across the thickness T2. The first side 145 can extend away from the second side 150. For example, the first side 145 can begin below the second aperture 140 and extend away to above the second aperture 140. The second side 150 can be below the second aperture 140 (e.g., a bottom side). For example, the second side 150 can be substantially parallel (e.g., +/−10% of parallel) or parallel with a horizontal surface supporting the vehicle 185, with the first side 145 extending away from the horizontal surface. The terms below and above are in reference to the horizontal surface, such that below is closer to the horizontal surface relative to the other element in the comparison and above is further from the horizontal surface relative to the other element in the comparison.

The bracket 100 can include at least one connecting portion 125 that connects the first flange 105 with the second flange 135. For example, the connecting portion 125 is connected proximate at least one first end 155 to the first flange 105 and proximate at least one second end 160 to the second flange 135. The connecting portion 125 can be connected to the first flange 105 and the second flange 135 along at least a portion of the second side 120 and second side 150. For example, the connecting portion 125 can connect to the first flange 105 along a portion of the second side 120 and the connecting portion 125 can connect to the second flange 135 along a portion of the second side 150 as depicted in FIGS. 1-4. The connecting portion 125 can additionally or alternatively be connected to the first flange 105 and the second flange 135 along at least a portion of the first side 115 and first side 145. For example, the connecting portion 125 can connect to the first flange 105 along a portion of the first side 115 and the connecting portion 125 can connect to the second flange 135 along a portion of the first side 145. The connecting portion 125 can connect the first flange 105 and the second flange 135 along at least a portion of the first side 115 and first side 145 and along at least a portion of the first side 145 and second side 150. For example, the connecting portion 125 can be bent to couple to both the first side 115 and first side 145 and the second side 120 and second side 150. The connecting portion 125 can be a third side 127 that connects the first side 115 to the second side 120 and the first side 145 to the second side 150. For example, the first side 115 can connect with the connecting portion 125 which in turn connects with the second side 120 of the first flange 105 as depicted in FIG. 5. The connecting portion 125 can be orthogonal to the first flange 105 and the second flange 135. For example the connecting portion 125 can connect with the first flange 105 and the second flange 135 at a right angle.

The connecting portion 125 can be a plate, an extension, a web, or a member. For example, the connecting portion 125 can be a plate having a thickness T3. The first flange 105, the second flange 135, and the connecting portion 125 can be monolithic and formed of a single member. For example, the first flange 105, the second flange 135, and the connecting portion 125 can be formed of a single plate that has been stamped or bent to form the first flange 105, the second flange 135, and the connecting portion 125 as shown in FIGS. 1-5. The first flange 105, the second flange 135, and the connecting portion 125 can be discrete elements coupled to each other (e.g., hinged, welded, glued, fastened) to form part of the bracket 100. For example, the connecting portion 125 can be welded to the first flange 105 along the portion of the second side 120 proximate the first end 155 of the connecting portion 125 and the connecting portion 125 can be welded to the second flange 135 along the portion of the second side 150 proximate the second end 160 of the connecting portion 125. The first flange 105, the second flange 135, and the connecting portion 125 can be made of the same material (e.g., metal, plastic, ceramic, or another material.). For example, the first flange 105, the second flange 135, and the connecting portion 125 can be made of aluminum, iron, steel, or alloys thereof. The first flange 105, the second flange 135, and the connecting portion 125 can be made of different materials or alloys. The bracket 100 has thicknesses of T1, T2, and T3. The thicknesses of T1, T2, and T3 can vary. For example, the thicknesses T1, T2, and T3, can be 0.125 inches, 0.25 inches, 0.5 inches, or another size. The thicknesses T1, T2, and T3 can vary depending on the material the first flange 105, the second flange 135, and the connecting portion 125. In some embodiments, the thicknesses T1, T2, and T3 can each be different. In some embodiments, the thicknesses T1, T2, and T3 can be substantially equal (e.g., +/−10%) or equal. In some embodiments, the thicknesses T1 and T2 can be different from T3.

The first flange 105, the second flange 135, and the connecting portion 125 can define a at least one U-shaped attachment surface 165 to couple the bracket 100 to the chassis 130. For example, the first side 115 of the first flange 105, the first side 145 of the second flange 135, and at least one rear side 170 of the connecting portion 125 can form a U-shaped arrangement configured to engage with the chassis 30 as a U-shaped attachment surface 165. The U-shaped attachment surface 165 can be a welding surface for welding the first flange 105, the second flange 135, and the connecting portion 125 to the chassis 130. In some embodiments, the connecting portion 125 is not a part of the attachment surface 165, which can be ∥ shaped, and include the first side 115 of the first flange 105 and the first side 145 of the second flange 135.

The first flange 105 and the second flange 135 can define at least one gap 175. The gap 175 can be a space, volume, void, opening, or location to receive a mounting plate 180 of a chassis 130 of a vehicle 185. The gap 175 can extend a distance D between the first flange 105 and the second flange 135. The distance D can be based on the connecting portion 125. For example, the length of the distance D can be defined by the length of the connecting portion 125 as depicted in FIGS. 1-5. The distance D can be greater than the distance between flanges of a control mount installed by a manufacturer of the vehicle 185 on the chassis 130. The greater distance D allows for a mounting point 197 of a control arm 195 to be moved forward towards a front of the vehicle 185 further than would otherwise be allowed by the manufacturer control mount, as depicted in FIG. 7. The gap 175 can accessible from at least one first direction 190 to receive a mounting plate 180 of the chassis 130. For example, the first direction 190 can extend from the attachment surface 165 towards a middle point between the first aperture 110 and the second aperture 140 (e.g., laterally away from a longitudinal centerline of the vehicle 185). The gap 175 can be accessible from at least one second direction 192 to receive the control arm 195. For example, the second direction 192 can pass from the first aperture 110 and second aperture 140 to the chassis 130 (e.g., towards a longitudinal centerline of the vehicle 185). The gap 175 can receive the mounting plate 180. As depicted in FIGS. 7-9 with reference to the below discussion, the mounting plate 180 can provide an initial point to the couple the bracket 100 with the chassis 130. For example, the bracket 100 can be bolted to the mounting plate 180 to hold the bracket 100 fast as the attachment surface 165 is welded. The mounting plate 180 can provide an alignment aid to the bracket 100. For example, the bracket 100 can be positioned for the gap 175 to receive the mounting plate 180. A fastener 200 can extend through the first flange 105, the second flange 135, and the mounting plate 180, aligning the first flange 105 and the second flange 135 (via the first aperture 110 and the second aperture 140) with the mounting plate 180. The alignment can serve as a reference mount for ensuring the bracket 100 is mounted to the chassis 130 at a location and angle appropriate to receive the control arm 195.

The bracket 100 can include at least one fastener 200. For example, the fastener 200 can be coupled with the first flange 105 and the second flange 135. The fastener 200 can be a bolt, screw, rod, stud, shaft, or other elongated member to couple the first flange 105 and the second flange 135. The fastener can be received by the first aperture 110 of the first flange 105 and the second aperture 140 of the second flange 135. For example, the fastener 200 can pass through the first aperture 110 and through the second aperture 140 as shown in FIGS. 1-2. As depicted in FIG. 7, the fastener 200 can couple the control arm 195 with the mounting plate 180, the first flange 105, and the second flange 135.

The bracket 100 can include at least one spacer 205. For example, a spacer 205 can be between the control arm 195 and at least one of the first flange 105 and the second flange 135 to set a mounting point 197 of the control arm 195. The spacer 205 can be made of a metal or plastic (e.g., ABS, aluminum, titanium, iron, steel, or another material.). For example, the spacer 205 can be an aluminum puck or washer. The spacer 205 can be any shape so long as the spacer 205 can fit within the gap 175. For example, the spacer 205 can be circular, square, hexagonal, or any other shape. The spacer 205 can include at least one central aperture 210 as depicted in FIG. 2. The central aperture 210 can receive the fastener 200. The spacer 205 can lie along the fastener 200 between the control arm 195 and at least one of the first flange 105 and the second flange 135. For example, a spacer 205 can be disposed on the fastener 200 between the control arm 195 and the second flange 135 as shown in FIG. 7. The bracket 100 can include a plurality of spacers 205. The number or the width of the spacers 205 can adjust a mounting point 197 of the control arm 195 in the bracket 100. For example, the second flange 135 can be positioned adjacent the mounting plate 180, and one or more spacers 205 can push the mounting point 197 of the control arm 195 away from the mounting plate 180 and the second flange 135 towards the first flange 105 and the front of the vehicle 185 as depicted in FIG. 7.

The mounting plate 180 can be a part of the chassis 130. For example, the vehicle 185 can include a plurality of mounting plates 180. As discussed below with reference to FIGS. 7-9, the mounting plate 180 can be a rear flange of a control arm mount installed by a manufacturer of the vehicle 185. For example, the mounting plate 180 can a part of an original, manufacturer installed control arm mounting point that included a front flange and a rear flange. The front flange can be removed, leaving the mounting plate 180 (e.g., the rear flange) in place on the chassis 130. The mounting plate 180 can extend into the gap 175 along the first direction 190 from the chassis 130.

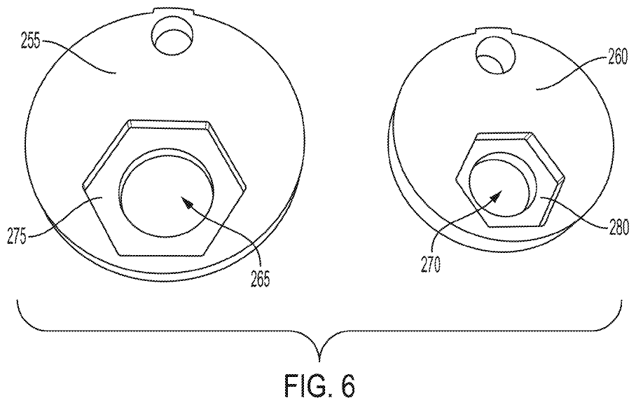

The bracket 100 can include at least one first cam 255 between at least one first plurality of cam tabs 215 on the first flange 105, and at least one second cam 260 between at least one second plurality of cams tabs 230 on the second flange 135 to adjust a camber angle and additionally or alternatively a caster angle of the vehicle. As discussed below with reference to FIG. 6, the first cam 255 can include at least one first cam aperture 265 and the second cam 260 can include at least one second cam aperture 270. The first cam 255 and the second cam 260 can be asymmetric about their respective rotational axes through the first cam aperture 265 and the second cam aperture 270. The first cam 255 and the second cam 260 can be shaped to transform rotatory motion of the first cam 255 and the second cam 260 into linear motion. For example, the first cam 255 and the second cam 260 can be snail-shaped, pear shaped, circular with an offset rotational axis, or in general any shape that is asymmetric about its rotational axis. For example, the first cam 255 and the second cam 260 can be oblongs, with a first cam aperture 265 in the first cam 255 and a second cam aperture 270 in the second cam 260 offset from a centers of the first cam 255 and the second cam 260, respectively. The first cam aperture 265 and the second cam aperture 270 can be positioned such that the shape of the first cam 255 is asymmetrical around the first cam aperture 265 and the shape of the second came 260 is asymmetrical around the second cam aperture 270.

The first cam 255 and the second cam 260 can include a first guide 278 and a second guide 280. The first guide 278 can be shaped to receive a head 202 of the fastener 200 and the second guide 280 can be shaped to receive a nut 204 of the fastener 200. For example, the first guide 278 can be hexagonal depression to at least partially receive a hexagonal head 202 of the fastener 200 and the second guide 280 can be a hexagonal depression to at least partially receive a hexagonal nut 204.

The first cam aperture 265 and the second cam aperture 270 can receive the fastener 200. Rotating the first cam 255 and the second cam 260 relative to the first plurality of cam tabs 215 and the second plurality of cam tabs 230 can adjust a position of the fastener 200 captured by the first cam aperture 265 and the second cam aperture 270 in the first aperture 110 and the second aperture 140 (e.g., as depicted in FIG. 7). The position of the fastener 200 in the first aperture 110 and the second aperture 140 can adjust the camber or caster of the vehicle 185.

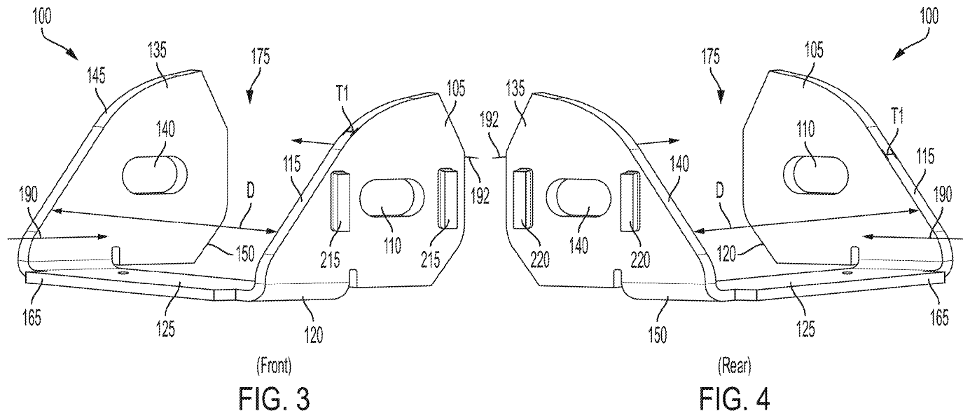

The first flange 105 can include a first plurality of cam tabs 215. For example, the first flange 105 can include at least one first outer face 220 including the first plurality of cam tabs 215. The first outer face 220 can face away from the second flange 135. As discussed below with reference to FIGS. 3-4, the first plurality of cam tabs 215 can extend from the first outer face 220. The first plurality of cam tabs 215 can include at least one first cam tab 225 and at least one second cam tab 227. The first plurality of cam tabs 215 can be positioned on opposite sides of the first aperture 110. For example, the first cam tab 225 can be positioned on a first side of the first aperture 110 between the first aperture 110 and the attachment surface 165 and the second cam tab 227 can be positioned on an opposite side of the first aperture 110. The first plurality of cam tabs 215 can extend vertically on the first outer face 220 relative to the ground surface. For example, the first cam tab 225 can have a length L along perpendicular to the elongated axis of the first aperture 110.

The second flange 135 can include a second plurality of cam tabs 230. For example, the second flange 135 can include a second outer face 235 including the first pair of cam tabs 230. As discussed below with reference to FIGS. 3-4, the second plurality of cam tabs 230 can extend from the second outer face 235. The second pair of cam tabs 250 can include a third cam tab 240 and a fourth cam tab 245. The second plurality of cam tabs 230 can be positioned on opposite sides of the second aperture 140. For example, the third cam tab 240 can be positioned on a first side of the second aperture 140 between the second aperture 140 and the attachment surface 165 and the fourth cam tab 245 can be positioned on an opposite side of the second aperture 140. The second plurality of cam tabs 230 can extend vertically on the second outer face 235 relative to the ground surface. For example, the third cam tab 240 can have a length L2 along perpendicular to the elongated axis of the second aperture 140.

The bracket 100 can include the first cam 255 between the first plurality of cam tabs 215 and the second cam 260 between the second plurality of cam tabs 230. For example, the first cam 255 can be adjacent to the first outer face 220 of the first flange 105 between the first plurality of cam tabs 215 (e.g., bracket 100 as depicted in FIG. 7) and the second cam 260 can adjacent to the second outer surface 235 of the second flange 135 between the second plurality of cam tabs 230 (e.g., bracket 100 as depicted in FIG. 1).

A rotational position 275 of at least one of the first cam 255 and the second cam 260 can define a camber and a caster angle. For example, because of the nature of the shape of the first cam 255 and the second cam 260, rotation of the first cam 255 and the second cam 260 can adjust a lateral position of the first cam aperture 265 and the second cam aperture 270 relative to the first plurality of cam tabs 215 and the second plurality of cam tabs 230. The fastener 200 can be received within the first cam aperture 265 and the second cam aperture 270. The rotation of the first cam 255 and the second cam 260 can therefore adjust a position of the fastener 200 relative to the first plurality of cam tabs 215 and the second plurality of cam tabs 230. For example, the fastener 200 can be received by the first aperture 110 and the second aperture 140. The first aperture 110 and the second aperture 140 can be elongated, with an elongated axis substantially parallel (e.g., +/−10% of parallel) or parallel to a horizontal surface beneath the vehicle 185. The fastener 200 be received within the first aperture 110 and the second aperture 140 and can couple the first cam 255 to the first flange 105 at the first outer face 220 and the second cam 260 with the second flange 135 at the second outer surface 235. Rotation of the first cam 255 and the second cam 260 can adjust a position of the fastener 200 within the first aperture 110 and the second aperture 140 along their elongated axes (e.g., towards or away from a longitudinal centerline of the vehicle 185).

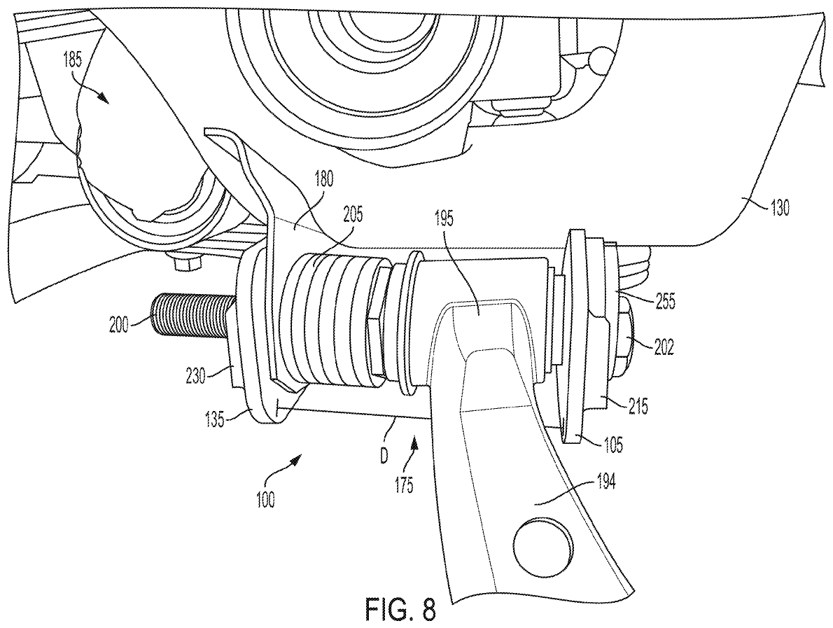

The bracket 100 can include the fastener 200 coupling the control arm 195 with the mounting plate 180, the first flange 105, and the second flange 135. For example, the fastener 200 can couple the control arm 195 with the mounting plate 180 and be received by the first aperture 110 of the first flange 105 and the second aperture 140 of the second flange 135. As discussed below with reference to FIGS. 7-8, the control arm 195 can receive the fastener 200. The mounting plate 180 can include an mounting plate aperture 182 to receive the fastener 200. For example, the fastener 200 can pass through each of the first aperture 110, the control arm 195, the mounting plate aperture 182, and the second aperture 140 and couple each of the control arm 195, the mounting plate 180, the first flange 105, and the second flange 135 between the head 202 of the fastener 200 and the nut 204 (not shown). An end 194 of the control arm 195 can pivotally couple the control arm 195 with the fastener 200. For example, the end 194 of the control arm 195 can include a rotatable bushing with an aperture to receive the fastener 200. The control arm 195 can rotate around the fastener 200 while the fastener 200 is contained with the control arm 195.

The mounting plate 180 can be parallel to the first flange 105 and the second flange 135. For example, as depicted in FIG. 7-8, the mounting plate 180 can be parallel with the first flange 105 and the second flange 135. The mounting plate 180 can include a mounting plate aperture (not shown) to receive the fastener 200. The mounting aperture can be axially aligned with the first aperture 110 and the second aperture 140. For example, a straight line can pass through the first aperture, the mounting plate aperture, and the second aperture 140. As described above, the mounting plate 180 can be an original component of the vehicle 185. For example, the mounting plate 180 can be a rear mounting plate for a manufacturer installed control arm mount. The bracket 100 can receive the mounting plate 180 to couple the bracket 100 to the chassis 130 and to provide a reference point for aligning the bracket 100 with the chassis 130 and the control arm 195.

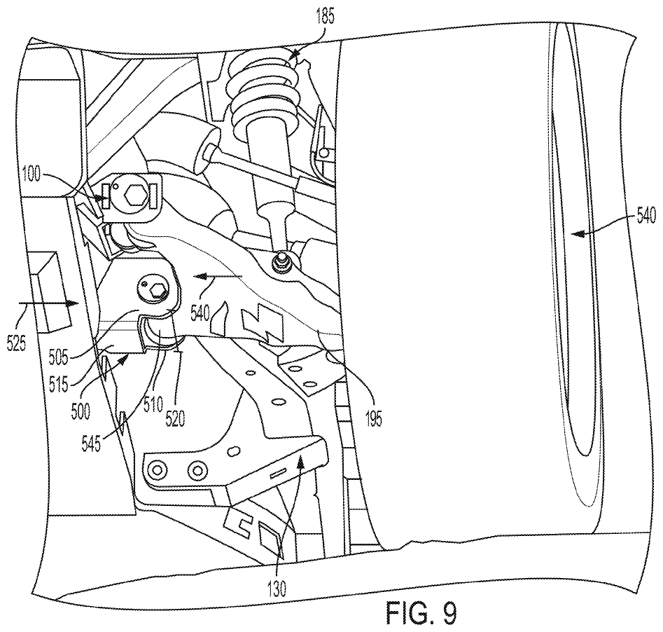

FIG. 9, among others, depicts a system 400 to mount a control arm 195 to a vehicle 185. The system 400 can include an apparatus to mount a control arm 195 of the control arm 195 to a vehicle 185. For example, the system 400 can include the apparatus 100. The system 400 can include a second apparatus to mount a second control arm end 545 to a chassis 130. For example, the apparatus 100 can be a front apparatus 100 and the system 400 can include a rear apparatus 500. The rear apparatus 500 may share one or more features as the apparatus 100. For example, the first rear flange 505 of the apparatus 500 may be the same as first flange 105 of the apparatus 100.

The rear apparatus 500 can include at least one first rear flange 505 (e.g., first flange 105), at least one second rear flange 510 (e.g., second flange 135), and at least one rear connecting portion 515 (connecting portion 125). The rear connecting portion 515 can connect the first rear flange 505 and the second rear flange 510. The first rear flange 505 and the second rear flange 510 define a rear gap 520 (e.g., gap 175). The rear gap 520 can be accessible from a third direction 525 (e.g., first direction 190) to receive a second mounting plate (not shown) (e.g., mounting plate 180) of the vehicle 185. The rear gap 520 can be accessible from a fourth direction 540 (e.g., second direction 192) to receive a second control arm end 545 (e.g., control arm 195). The rear apparatus 500 can include a rear fastener (not shown) (e.g., fastener 200) to couple with the first rear flange 505 and the second rear flange 510. The rear fastener can couple the second control arm end 545 of the control arm 195 to the chassis 130.

The rear apparatus 500 can be independent of the front apparatus 100. For example, the front apparatus 100 can couple with the chassis 130 independently of the second apparatus 500. The independent second apparatus 500 can couple to a different point of the chassis 130 and be aligned, positioned, arranged, apart from the front apparatus 100. The independent rear apparatus 500 allows for alignment of the rear apparatus 500 without affecting the placement, position, location, or alignment of the apparatus 100.

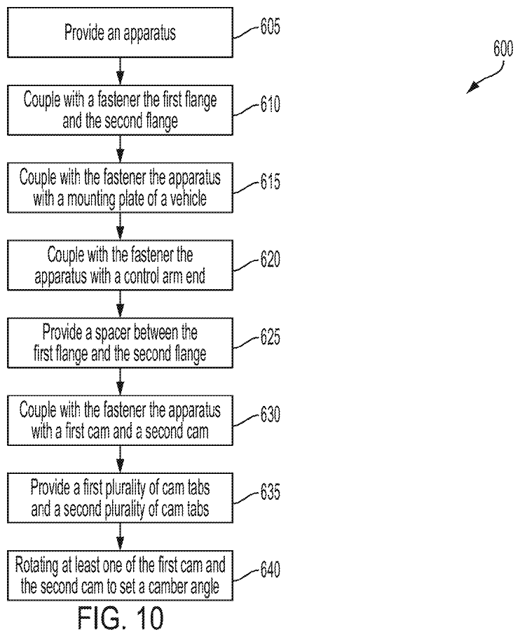

FIG. 10 is a flow chart of a method 600. The method 600 can be a method of mounting a control arm with a vehicle. For example, the method 600 can be a method of mounting a control arm 195 of a control arm 195 with a vehicle 185. The method 600 can include one or more ACTS 605-640. For example, one or more ACTS 605-640 can be optional. The method 600 can include ACTS 605-640 performed in the order shown in FIG. 10 or in some other order.

The method 600 can include providing an apparatus at ACT 605. For example, the method can include providing apparatus 100 at ACT 605. The apparatus 100 can include a first flange 105, a second flange 135, and a connecting portion 125 that connects the first flange 105 with the second flange 135. The first flange 105 can include a first side 115 (e.g., a curved side) and a second side 120 (e.g., a bottom side). The second flange 135 can include a first side 145 (e.g., a curved side) and a second side 150 (e.g., a bottom side). The connecting portion 125 can connect the first flange 105 with the second flange 135 along the first side 115 and first side 145. The connecting portion 125 can connect the first flange 105 with the second flange 135 along the second side 120 and second side 150. The connecting portion 125 can connect the first flange 105 and the second flange 135 as a third side 127 between the first side 115 and second side 120 and between the first side 145 and the second side 150. The first flange 105 and the second flange 135 can define a gap 175. The gap 175 can receive a mounting plate 180 of the chassis 130. The gap 175 can receive a control arm 195. The gap 175 can extend between the first flange 105 and the second flange 135 a distance D. The distance D can depend on a length of the connecting portion 125.

The method 600 can include coupling the first flange with the second flange at ACT 610. For example, the method 600 can include coupling the first flange 105 and the second flange 135 at ACT 610. The method 600 can include coupling the first flange 105 and the second flange 135 with a clip, a latch, a bolt, a screw, a rod, a shaft, a stud, or another kind of coupling mechanism. For example, the method 600 can include coupling the first flange 105 and the second flange 135 via the fastener 200. The fastener 200 can be received by the first aperture 110 of the first flange 105 and the second aperture 140 of the second flange 135. For example, the fastener 200 can pass through the first aperture 110 and through the second aperture 140 as shown in FIG. 1. The fastener 200 can be substantially (e.g., +/−10% from straight) straight or the fastener 200 can be curved.

The method 600 can include coupling the apparatus with a mounting plate at ACT 615. For example, the method 600 can include coupling the apparatus 100 with a mounting plate 180 at ACT 615. The mounting plate 180 can be a part of the chassis 130 of the vehicle 185 and can be provided by the manufacturer for mounting a control arm. The manufacturer may provide a front mounting plate and a rear mounting plate (e.g., the mounting plate 180) for mounting a control arm 195 to the vehicle 185. The front mounting plate can be removed to make room for the apparatus 100. The mounting plate 180 (e.g., the rear mounting plate) can remain and be coupled with the fastener 200 to the first flange 105 and the second flange 135. The mounting plate 180 can be adjacent the first flange 105 or the second flange 135. The mounting plate 180 can be positioned between the first flange 105 and the second flange 135. The apparatus 100 can receive the mounting plate in the gap 175 defined by the first flange 105 and the second flange 135. The method 600 can include coupling the apparatus 100 with the mounting plate 180 with a clip, latch, bolt, screw, rod, shaft, stud, or another kind of coupling mechanism. For example, the method 600 can include coupling the apparatus 100 with the mounting plate 180 via the fastener 200. The method 600 can also include coupling the apparatus 100 with the mounting plate 180 via fastener apart from the fastener 200. For example, a second fastener, similar to fastener 200, can couple the apparatus 100 with the mounting plate 180. The first aperture 110 and the second aperture 140 can receive the second fastener. For example, the second fastener and the fastener 200 can both pass through one of or both the first aperture 110 or the second aperture 140.

The method 600 can include coupling the apparatus with a control arm at ACT 620. For example, the method 600 can include coupling the apparatus 100 with a control arm 195 at ACT 620. The control arm 195 can be pivotally coupled at an end 194 of the control arm with the apparatus 100. For example, the end 194 of the control arm 195 can include a rotatable bushing to allow the control arm 195 to couple with and rotate relative to the apparatus 100. The method 600 can include coupling the apparatus 100 with the control arm 195 at any point along the control arm, directly or indirectly. For example, the method 600 can include coupling the control arm 195 to an intermediate member and coupling the apparatus 100 to the intermediate member. The method 600 can include coupling the apparatus with the control arm via a clip, latch, bolt, screw, rod, shaft, stud, or another kind of coupling mechanism. For example, the method 600 can include coupling the apparatus 100 with the control arm 105 via the fastener 200. The fastener 200 can couple with the control arm 195 at any point along the control arm 195. For example, the fastener 200 can couple with an end 194 of the control arm 195. The end 194 of the control arm 195 can be rotatably coupled to the fastener 200. For example, the end 194 of the control arm 195 can be a rotatable bushing, a bearing, an aperture, a link, or another structure. The fastener 200 can pass through the control arm 195 to couple the control arm 195 with the apparatus 100. For example, the fastener 200 can be a bolt with a head 202 and a nut 204. The head 202 can engage with the first flange 105 and the nut 204 can engage with the second flange 135. The control arm 195 can be positioned between the first flange 105 and the second flange 135, such that the head 202 and the nut 204 capture the control arm 195.

The method 600 can include providing a spacer at ACT 625. For example, the method 600 can include providing at least one spacer 205 at ACT 625. The spacer can be a part of the apparatus. For example, the spacer can be spacer 205 of apparatus 100. The spacer 205 can be made of plastic, metal, ceramic, or another material. For example, the spacer 205 can be made of aluminum. The method 600 can include providing a single spacer 205 or multiple spacers 205. For example, as depicted in FIG. 10, the four spacers 205 can be provided between the control arm 195 and the second flange 135. The spacer 205 can be circular or polygonal (e.g., a circle, a square, a hexagon or another shape). For example, the spacer can be shaped like a circular or substantially (e.g., +/−10%) circular puck. The method 600 can include providing a spacer adjacent at least one of the first flange or the second flange. For example, the method 600 can include providing the spacer 205 proximate the first outer side 220 of the first flange. The method 600 can include providing the spacer 205 between the first flange and the second flange. For example, the spacer 205 can be provided between the first flange 105 and the second flange 135. The spacer 205 can be provided between the control arm 195 and at least one the first flange 105 and the second flange 135. For example, the spacer 205 can be provided between an end 194 of the control arm 195 and the second flange 135. The spacer 205 can be provided between the control arm 195 and the mounting plate 180. For example, the spacer 205 can lie between the end 194 of the control arm 195 and the second flange 135. The spacer 205 can be received in a gap. For example, the spacer 205 can be received in the gap 275 defined by the first flange 105 and the second flange 135. For example, one or more spacers 205 can occupy the gap 175 in addition to the mounting plate 180 and the control arm 195.

The method 600 can include providing a cam tab. For example, the method 600 can include providing a first cam tab 225. The cam tab can be a part of the apparatus. For example, the cam tab can be a part of apparatus 100. The first cam 225 can be positioned proximate an aperture of a flange of the apparatus 100. For example, the first cam tab 225 can be positioned on flange 105 on a first side of the aperture 110 between the aperture 110 and the chassis 130. The first cam tab can be provided on a face of a flange facing the opposing flange or on a face of a flange facing away from the opposing flange. For example, the first cam tab 225 can be provided on a second outer face 235 of the second flange 135. The method 600 can including providing a plurality of cam tabs. For example, the method 600 can include providing the first plurality of cam tabs 215. The first plurality of cam tabs 215 can be positioned on a same surface of a flange. For example, the first plurality of cam tabs 215 can be positioned on the first outer surface 220 of the first flange 105. The plurality of cam tabs can be positioned on opposing sides of an aperture of a flange. For example, the second plurality of cam tabs 230 is provided on opposing sides of the second aperture 140 on the second flange 135. The method 600 can include providing a first plurality of cam tabs and a second plurality of cam tabs at ACT 630. For example, the method 600 can include providing a first plurality of cam tabs 215 and providing a second plurality of cam tabs 230 at ACT 630. The first plurality of cam tabs and the second plurality of cam tabs can be provided on opposing flanges of the apparatus. For example, the first plurality of cam tabs 215 can be provided on the first flange 105 and the second plurality of cam tabs 230 can be provided on the second flange 135. Specifically, the first plurality of cam tabs 215 can be provided around a first aperture 110 on the first flange 105, and the second plurality of cam tabs 230 can be provided around a second aperture 140 of the second flange 135. The first plurality of cam tabs can be provided a first outer face 220 of the first flange 2015 and the second plurality of cam tabs 230 can be provided on a second outer face 235 of the second flange 135. The first outer face 220 can face away from the second flange 135, and the second outer face 235 can face away from the first flange 105. The first plurality of cam tabs 215 can include a first cam tab 225 and a second cam tab 227. The first cam tab 225 and the second cam tab 227 can be positioned on opposite sides of a first aperture 110. For example, the first aperture 110 can be elongated, and the first cam tab 225 and the second cam tab 227 can be positioned on either side of the elongated ends of the first aperture 110. The first plurality of cam tabs 215 can receive between them the first cam 255 and the second plurality of cam tabs 230 can receive between them the second cam 260.

The method 600 can include coupling the apparatus with a cam at ACT 630. For example, the method 600 can include coupling the apparatus 100 with a first cam 255. The cam can be a part of the apparatus. For example, the cam can be a first cam 255 of the apparatus 100. The cam can engage, contact, or otherwise act upon a cam tab. For example, the second cam 260 can make contact with the fourth cam tab 245. The method 600 can include providing a cam for acting upon each plurality of cam tabs. For example, the method 600 can include a first cam 255 to engage with the first plurality of cam tabs 215 and a second cam 260 to engage with the second plurality of cam tabs 230. The first cam 255 can be provided on a first outer face 220 of the first flange 105 and the second cam 260 can be provided on a second outer face 235 of the second flange 135. The cam can couple to the fastener 200. For example, the first cam 255 can include a first cam aperture 265 to receive the fastener 200. The cam can rotate asymmetrically about an axis. For example, the first cam aperture 265 can be placed offset from a center of mass of the first cam 255, offset from a center of gravity of the first cam 255, or at any other location such that the first cam is asymmetric about the first cam aperture 265. The second cam aperture 270 can be placed offset from a center of mass of the second cam 260, offset from a center of gravity of the second cam 260, offset from a centroid, or at any other location such that the first cam is asymmetric about the rotational axis.

The method 600 can include rotating a cam ACT 640. For example, the method 600 can include rotating a first cam 255. The cam can be asymmetric about its rotational axis. For example, the cam can be a cam 255 with a first cam aperture 265 offset from a center of mass of the first cam 255. The cam can have a rotational position relative to the cam tabs. For example, the cam can be asymmetric, such that positions of the cam and the cam tabs change as the cam rotates. The cam rotational position can change by rotating the cam. For example, setting a rotational position 275 can include rotating a first cam 255 relative to the first cam tabs 215. The first cam 255 can contact, engage, slide, or otherwise interact with the first plurality of cam tabs 215, respectively, to adjust its rotational position. The cam can couple with a fastener. For example, the cam can include an aperture, engagement zone, link, clip, screw, rod, shaft, stud, bolt or another structure to couple with a fastener of the apparatus 100. For example, the first cam 255 can include a first cam aperture 265 to receive the fastener 200. The rotational position of the cam can adjust a position of the fastener. For example, the first cam 255 can be coupled to the fastener 200, and adjustments to the rotational position of the cam 255, due to engagement of the cam 255 and the first plurality of cam tabs 215, can move the fastener 200 within the first aperture 110. For example, the first aperture 110 and the second aperture 140 can have a larger opening then the outer perimeter of at least a portion of the fastener 200. The fastener 200 can be received in various positions within the first aperture 110 and the second aperture 140 because of the size of the first aperture 110 and the second aperture 140. The fastener 200 is received by the first cam 255 and the second cam 260, such that the rotational position 275 of the first cam tab 225 relative to the first plurality of cam tabs 215 and of the second cam 260 relative to the second plurality of cam tabs 230 controls the position of the fastener 200 within the first aperture 110 and the second aperture 140.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are coupling, with the fastener, the apparatus with a control arm end not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be mechanically or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus to mount a control arm with a vehicle, comprising:
a first flange;
a second flange;
a connecting portion that connects the first flange with the second flange;
the first flange and the second flange define a gap to receive a mounting plate of a chassis of the vehicle;
a fastener coupled with the first flange and the second flange;
the fastener to couple a control arm with the mounting plate.

2. The apparatus of claim 1, comprising:
a spacer between the control arm and at least one of the first flange and the second flange to set a mounting point of the control arm.

3. The apparatus of claim 1, wherein the mounting plate is parallel to at least one of the first flange and the second flange.

4. The apparatus of claim 1, comprising;
the fastener to couple the control arm with the mounting plate, the first flange, and the second flange.

5. The apparatus of claim 1, comprising:
the first flange including a first aperture;
the second flange including a second aperture; and
the first aperture and the second aperture to receive the fastener.

6. The apparatus of claim 1, comprising:
a first outer face of the first flange including a first plurality of cam tabs; and
a second outer face of the second flange including a second plurality of cam tabs; and
a first cam between the first plurality of cam tabs and a second cam between the second plurality of cam tabs;
a rotational position of at least one of the first cam and the second cam to define at least one of a camber angle or a caster angle.

7. The apparatus of claim 1, comprising;
the first flange, the second flange, and the connecting portion define a U-shaped attachment surface to couple the apparatus to the chassis.

8. An system to mount a control arm to a vehicle, comprising:
an apparatus comprising:
a first flange;
a second flange;
a connecting portion that connects the first flange to the second flange;
the first flange and the second flange define a gap accessible from a first direction to receive a mounting plate of a chassis of the vehicle;
a fastener coupled with the first flange and the second flange;
the gap accessible from a second direction to receive a control arm;
the fastener to couple the control arm with the mounting plate.

9. The system of claim 8, comprising,
the first flange, the second flange, and the connecting portion are monolithic.

10. The system of claim 8, comprising:
a spacer between the control arm and at least one of the first flange and the second flange to set a mounting point of the control arm.

11. The system of claim 10, comprising:
the first flange including a first aperture;
the second flange including a second aperture;
the first aperture and the second aperture to receive the fastener.

12. The system of claim 8, comprising:
the first flange, the second flange, and the connecting portion define a U-shaped attachment surface to couple the apparatus to the chassis.

13. The system of claim 8, wherein the apparatus is a front apparatus, the first flange is a first front flange, the second flange is a second front flange, the connecting portion is a front connecting portion, and the fastener is a first fastener, comprising:
a rear apparatus independent of the front apparatus, the rear apparatus comprising:
a first rear flange;
a second rear flange;
a rear connecting portion that connects the first rear flange to the second rear flange;
the first rear flange and the second rear flange define a rear gap accessible from a third direction to receive a second mounting plate of a chassis of the vehicle;
a rear fastener coupled with the first rear flange and the second rear flange;
the rear gap accessible from a fourth direction to receive the control arm;
the rear fastener to couple the control arm with the rear mounting plate.

14. The system of claim 8, comprising:
a second apparatus independent of the apparatus;
the apparatus and the second apparatus to couple the control arm with the vehicle.

15. A method to mount a control arm with a vehicle, comprising:
providing an apparatus, the apparatus including a first flange, a second flange, and a connecting portion that connects the first flange with the second flange;
coupling, with a fastener, the first flange and the second flange;
coupling, with the fastener, the apparatus with a mounting plate of a chassis of the vehicle; and
coupling, with the fastener, the apparatus with a control arm.

16. The method of claim 15, comprising:
providing, a spacer between the first flange and the second flange.

17. The method of claim 15, comprising:
coupling, with the fastener, the apparatus with a first cam and a second cam; and
rotating at least one of the first cam and the second cam to set at least one of a camber angle or a caster angle.

18. The method of claim 15, comprising:
providing, on the first flange, a first plurality of cam tabs;
providing, on the second flange, a second plurality of cam tabs;
providing, on the fastener, a first cam and a second cam; and
a rotational position of at least one of the first cam and the second cam to define a camber angle.

19. The method of claim 15, comprising:
the first flange including a first aperture;
the second flange including a second aperture; and
the first and second aperture to receive the fastener.

20. The method of claim 15, comprising:
the first flange, the second flange, and the connecting portion define a U-shaped welding surface to couple the apparatus to the chassis.
